(19) United States
(12) Patent Application Publication
(10) Pub. No.: US 2017/0053378 A1
(43) Pub. Date: Feb. 23, 2017

(54) METHODS OF ENHANCING DIGITAL IMAGES

(71) Applicant: James Chen, Portland, OR (US)

(72) Inventor: James Chen, Portland, OR (US)

(73) Assignee: OREGON HEALTH & SCIENCE UNIVERSITY, PORTLAND, OR (US)

(21) Appl. No.: 15/241,893

(22) Filed: Aug. 19, 2016

Related U.S. Application Data
(60) Provisional application No. 62/207,711, filed on Aug. 20, 2015.

(51) Int. Cl. G06T 3/40; G06T 15/08; G06T 5/50

(52) U.S. Cl. CPC G06T 3/4007; G06T 5/50; G06T 15/08; G06T 2210/36

(57) ABSTRACT

Disclosed are methods of enhancing the resolution of 2-dimensional digital images and 3-dimensional volume reconstructions by using the random translational shifts and rotations present in a series of raw images to generate a single higher resolution image or volume. The methods allow the generation of a super-resolution image or volume reconstruction whose resolution exceeds the Nyquist limit of the original raw images.

### FIELD

Generally, the field involves enhancing digital images; more specifically, the field involves methods of enhancing the resolution of 2D and 3D digital images beyond the Nyquist frequency of raw data.

### BACKGROUND

Recent rapid advances in single-particle electron microscopy (EM), and cryo-EM in particular, have enabled macromolecular structure determination at near-atomic and even atomic resolution (Bartesaghi A et al, Science 348, 1147-1151 (2015); Campbell M G et al, eLife 06380 (2015); Liao M et al, Nature 504, 107-112 (2013); all of which are incorporated by reference herein). In cryo-EM data collection, single-particle images are recorded in movie frames by direct electron detectors that enable imaging-dose optimization and specimen-drift compensation (Brilot A F et al, J Struct Biol 177, 630-637 (2012); incorporated by reference herein). Once high-quality data has been acquired and the alignment of each particle has been determined (either explicitly or statistically), the 3D reconstruction can proceed following the so called “central section” theorem (DeRosier D et al, Nature 217, 130-134 (1968); incorporated herein by reference)—the Fourier transform (FT) of particle images is properly weighted and inserted into a single 3D Fourier space, from which an inverse-FT produces a 3D density map of the object. In this procedure, the highest resolution of each particle image is governed by its Nyquist frequency. As a result, the maximal information content in the filled 3D space is limited to the same Nyquist frequency.

One method of overcoming the so-called “Nyquist barrier” involves a hardware-based pixel fractioning technique. As implemented in the super-resolution mode of the Gatan K2 camera (Gatan Inc.), data images at one-half of the physical pixel spacing can be created through analyzing electron scattering patterns among neighboring pixels on the detector. However, because the electron scattering signal from a single event is highly noisy, the statistics are unreliable and significant error exists in the derived subpixel coordinates. To date, none of the 3D reconstructions from K2 super-resolution imaging have surpassed the physical Nyquist frequency in resolution.

### SUMMARY

The Nyquist frequency dictates the highest resolution of information in an image. However, this principle holds only in the case of a single image. In a set of images from the same object but with random inter-frame translation, the set includes information that can permit resolution even beyond the Nyquist frequency. Described herein is an algorithm that is validated to retrieve such information in 2D and 3D space. Its application in (for example) single-particle electron microscopy can lead to high-throughput data collection and density map reconstruction at higher resolution.

Disclosed herein are methods of increasing the resolution of a 2-dimensional digital image, thereby increasing its information content. The method, herein referred to as super resolution refinement (SR-refinement), involves obtaining a set of images that have random inter-frame subpixel shifts originated from affine transformations (X/Y translation, in-plane rotation and scaling). From the set of images, an initial registration is generated which can be used to convert the images into an aligned frame stack. The images in the aligned frame stack are summed to generate a single reference image. This reference image is oversampled by a factor greater than 1.0 (e.g., 1.5-fold or 2-fold), which results in a super resolution image (the initial template). The agreement between the raw images and the super resolution image is assessed via a scoring function. This scoring function may take the form of a cross-correlation score or any form of statistical scoring, such as maximum-likelihood. An example of one form of scoring function is presented in Example 2 below. The method further involves modifying one or more pixel intensities in the super resolution image by perturbing their intensity values in a random or systemic manner. An example formula for generating this modification value is presented in Example 2 below, wherein a random modification is introduced one random pixel at a time. This generates a modified super resolution image and a new score for the modified super resolution image is calculated. If the new score improves, the modification is accepted and the modified super resolution image is substituted for the initial super resolution image. This modify-evaluate process can continue for many iterations (the inner-loop) until no further improvement can be achieved in the score. Then, raw images will be re-aligned to the current super-resolution image and the process of modify-evaluate is repeated (the outer-loop).

Disclosed herein are methods of increasing the resolution of a reconstructed 3-dimensional density map, thereby increasing its information content. The method involves obtaining a set of images from many different views in 3D. From the set of images, an initial 3D model is created following the central-section theorem or other appropriate 3D reconstruction method. This initial 3D model (density map) is then oversampled by a factor greater than 1.0 (e.g., 1.5-fold or 2-fold), which results in a super resolution density map (the initial template). The agreement between raw images and the corresponding model projections is assessed by a scoring function. An example of such a scoring function is presented in Example 3 below. The method further involves modifying one or more voxel values of the super resolution map, either by a random or systematic modification similar to that used in the 2-D case. This generates a modified super resolution map and a new score for the modified super resolution map is calculated. If the new score improves, the modification is accepted and the modified super resolution image is substituted for the initial super resolution image. This modify-evaluate process repeats many iterations till no further improvement can be achieved in the score (the inner-loop). Then, the raw images will be re-aligned to the current super-resolution map, and the process of modify-evaluate is repeated (the outer-loop).

In either of the methods, oversampling can be performed by any method, including bilinear interpolation, bicubic interpolation and padding in the Fourier space. Oversampling can be by any factor higher than 1.0 (either integer or fraction). The pixel/voxel intensity can be modified by any method (either collectively or individually), including the scheme defined in Example 2 below. In 3D reconstruction, the initial template can be created either by frame insertion in the Fourier-space, frame back-projection in the real-space, or other 3D reconstruction methods. The 2D/3D super resolution refinement method can be performed on a digital image obtained from any source including an electron microscope, a light microscope, a radio telescope, an OCT device, a digital photography camera, or any other instrument that produces digital images.

### BRIEF DESCRIPTION OF THE SEVERAL VIEWS OF THE DRAWINGS

FIG. 1 is set of eight drawings which collectively illustrate the principle behind the methods described herein. The drawings represent a triangular object and its images acquired on a digital camera with random translation. In the simulation of image formation, the intensity of each pixel is proportional to the uncovered area in that pixel. The top panels represent instances of translation with respect to the pixel array of the camera. The bottom panels represent corresponding images recorded by the camera, which can differ significantly due to the random translation. In fact, this type of variation originated from subpixel translation naturally occurs in single-particle EM images acquired on direct detectors.

FIG. 2A is an illustration of the process used in super resolution 2D image merging.

FIG. 2B is an illustration of the process used in super resolution 3D image merging.

FIG. 3 (Panel A) is the image that serves as the high-resolution source for data synthesis and ground-truth control in the SR method evaluation. Figure (Panel B) is a set of four images showing examples of synthesized low-resolution images, each with random subpixel translation. The pixilation in the display is due to frame enlargement from 64×64 to 128×128 without interpolation. (Panel C) is a set of four images illustrating the progress of SR merging, in which the first frame is the initial template. After 15 iterations (the outer-loop in FIG. 2A) of SR-refinement, I_{SR} reaches CC=0.990 relative to the image in Panel A (binned to 128×128).

FIG. 4A is an SR density map (gold, 128×128×128, 2.0 Å/voxel) of the 20S proteasome, refined from 2,000 synthetic raw images (64×64) at 4.0 Å/pixel. The resolution of the SR-map has reached 5.3 Å measured by FSC^{0.143} against the standard, while the Nyquist frequency of the raw images is 8.0 Å.

FIG. 4B is a conventional 3-D reconstruction (following the central-section theorem, that inserts 2-D images into a single 3-D volume in Fourier space) of the 20S proteasome (gray, 64×64×64, 4.0 Å/voxel) on the same dataset at much lower-resolution.

FIG. 4C is a plot showing Fourier Shell Correlation (FSC) snap-shots in the 20S proteasome test case as the SR refinement progresses. The gray curves are from the 2,000-particle dataset. The resolution of its 3-D reconstruction improves as the iterative SR refinement continues and eventually reaches 5.3 Å (FSC^{0.143}). The black curve is from the refined SR-map using 5,000 particles, and its resolution extends to 4.4 Å.

FIG. 5 is a is a schematic depiction of an example of a computing system in accordance with the disclosure.

### DETAILED DESCRIPTION

Unless otherwise explained, all technical and scientific terms used herein have the same meaning as commonly understood by one of ordinary skill in the art to which this disclosure belongs. The singular terms “a,” “an,” and “the” include plural referents unless context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” In addition, the materials, methods, and examples are illustrative only and not intended to be limiting. In order to facilitate review of the various embodiments of the disclosure, the following explanations of specific terms are provided:

Pixel: A pixel is the basic programmable unit on a computer display or in a digital image. The physical size of a pixel depends on the imaging hardware device (camera) and its magnification.

Voxel: the basic element of a 3D density map or volume.

2D Oversampling: Resampling an image using more pixels. As a result, interpolation will occur for pixel values between the original pixel array. Oversampling may make an image appear smoother, but it does not increase the actual information content.

3D Oversampling: Resampling a density map (or volume) using more voxels. As a result, interpolation will occur for voxel values between the original voxel array. Oversampling may make a map appear smoother, but it does not increase the actual information content.

Resolution: the finest meaningful detail present in an image or map.

Nyquist Frequency: the highest frequency of information or detail that can be represented in a fixed image array (typically 2D or 3D for images, but higher dimensional data is possible).

Although the Nyquist frequency sets the physical limit of resolution in a single image, information in the image beyond the Nyquist frequency from the imaging target is not completely absent—it is aliased downward and mixed with the information in the lower-frequency domain. Using a single image, the mixing cannot be decoupled and the high frequency information is inaccessible. However, in a set of images comprising varying subpixel translations, the aliasing differs in phase shift and produces different patterns of intensity variation. That is, the set of images actually encodes information beyond the Nyquist frequency.

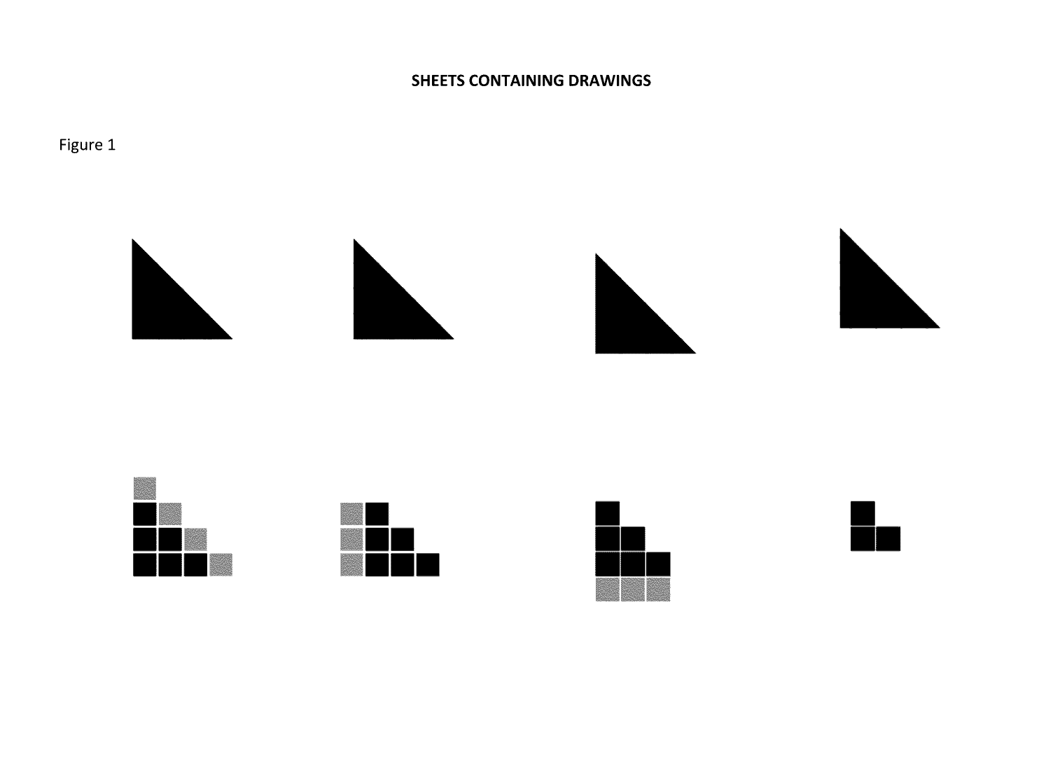

The principle is illustrated in FIG. 1, projections of a triangle recorded on a digital camera can differ significantly due to translation with respect to the 2D pixel array. This principle translates well to the example of single-particle EM data; due to the random distribution of particles on a specimen grid, subpixel translational variation occurs naturally. When properly analyzed, it is feasible to retrieve the differential information embedded among multiple frames and thus to enhance the resolution of a 3D reconstruction.

As described herein, images from a digital camera are termed the “raw data” or “raw images”, with “physical pixels” at the “physical resolution”. The process of retrieving high-resolution information from a set of raw images is termed “super-resolution” (SR) refinement, and the refined image (2D) or density map (3D) at higher-resolution is referred to as an SR-image (with SR-pixels) or SR-map (with SR-voxels), respectively.

As single-particle EM 3D reconstruction advances, the detective quantum efficiency (DQE) and pixel size of imaging detectors have become a major physical limitation to higher resolution images. In order to overcome this limitation, higher imaging magnification and higher radiation dosages have to be used in data acquisition. However, such remedies can lead to severe radiation damage to the specimen and consequently lower resolution in 3D reconstruction. Described herein is a super-resolution algorithm that enables data collection at lower magnification but achieves higher resolution in macromolecular structure elucidation.

The disclosed SR method can be utilized to pre-process micrograph frames from a high-speed movie recording, in which beam-induced specimen movement or mechanical instability of the specimen stage actually generates the inter-frame subpixel shifts required by the SR algorithm. Subpixel shifts may also be introduced deliberately during image acquisition by mechanical means such as piezoelectric actuators or other devices incorporated into the acquisition system. After SR merging, the micrographs at super-resolution can serve as the raw data for the subsequent image processing and 3D reconstruction. In practice, in order to obtain thousands of movie frames on the same target while avoiding severe radiation damage (especially in cryo-EM), the data need to be collected at low magnification with a nanometer pixel size. With the advantage of a large field-of-view, one application of the disclosed method is in high-throughput data collection for initial model reconstructions and structural heterogeneity characterization.

### EXAMPLES

### Example 1

### Computational Methods of Super Resolution Refinement

In the proposed SR refinement exemplified here, it is assumed that all raw images are from the same object at a fixed conformation, and each raw frame is free of motion blurring and has been properly aligned at the physical resolution. This section investigates the computational aspect of SR refinement, first in 2D image merging and then in 3D reconstruction.

### Example 2

### 2D Image Merging

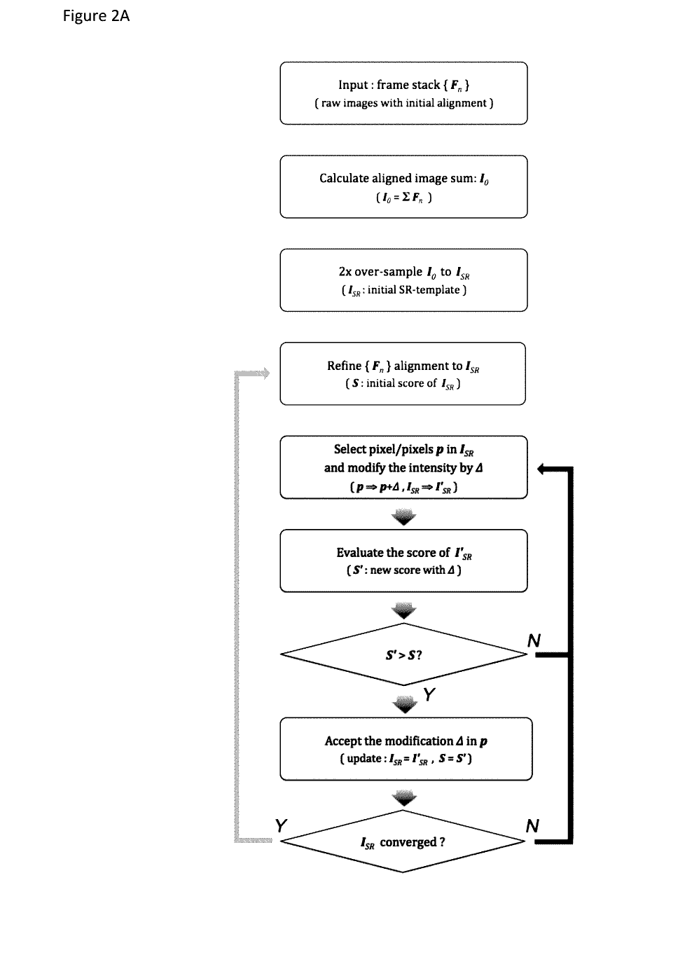

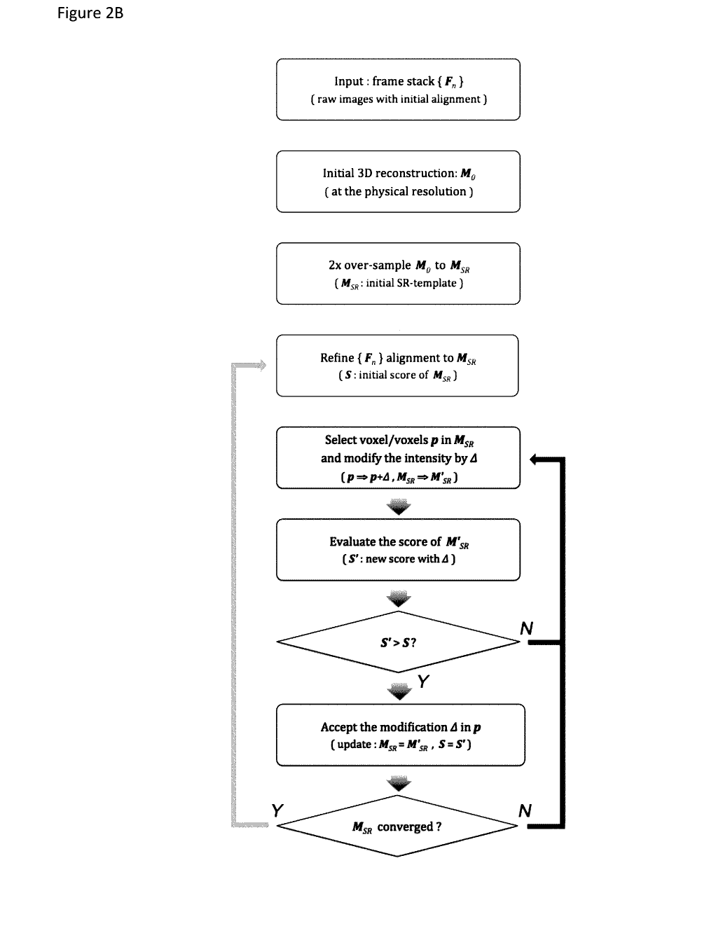

Given a set of raw images (m×m 2D pixel array) with a random subpixel shift, the task of merging them into a single image (2 m×2 m pixel array, with spacing at one-half of the physical pixel) is to solve for the intensity of individual pixels in the SR image. The solution can be derived via a computational procedure that iteratively adjusts pixel values of the SR-image to optimize its match to the full set of raw images. The flowchart in FIG. 2A illustrates the SR-refinement algorithm, in which

1. Raw images {Fₙ} (n=1 . . .N) with initial alignment {ξₙ} (in-plane X/Y-shifts) are the input data.

2. Sum up all aligned raw images into a single image I₀ (the image can still be m×m in dimension at the physical pixel size).

3. 2x over-sample I₀to I_{SR} (now at 2 m×2 m). This reduces the pixel size by half and doubles the Nyquist frequency in the SR-space. The over-sampling can be processed via padding in the Fourier space. I_{SR} now serves as the initial template of the SR-image.

4. Refine the alignment of each raw image in {Fₙ} to I_{SR} via local search in the SR-space.

The scoring function in the alignment optimization is defined as Equation (1)

$$S = {\sum }_{n = 1}^{N} {CC}_{n} = {\sum }_{n = 1}^{N} bin ( {I}_{SR} , {ξ}_{n} ) ⊗ {F}_{n} \qquad ( 1 )$$

in which bin(I_{SR}, ξₙ) applies the inversed alignment ξₙ of frame Fₙ to I_{SR} to remove full pixel dx, dy translations before reducing the dimension of the SR-image from 2 m×2 m back to m×m. The binned SR-image now has direct pixel correspondence to each raw image in Fₙ for their cross-correlation CCₙ evaluation ( [symbol] denotes the cross-correlation operator). The initial score S of I_{SR} at the current iteration is the sum of CCₙ over all raw images.

5. Randomly select one pixel in the SR-image and perturb its intensity by a small, random amount Δ that is proportional to the standard deviation of intensity in I_{SR} as defined in Equation (2).

Δ=k*s.t.d.(I_{SR})*rand( ) (2)

The scaling factor k is found to be optimal in the range of 10-20%, and ( ) is a random-number generator producing a value in the range of (0.0, 1.0). After the pixel perturbation, I_{SR} becomes I′SR.

6. Evaluate the score S′ of the perturbed SR-image I′_{SR}. If the score increases, then the pixel perturbation Δ will be accepted, and I′_{SR} becomes the updated version of I_{SR}. This process continues with another random pixel selection (the inner-loop back to box #5 of FIG. 2A) until no further improvement can be obtained in the score of I_{SR} under the current alignment {ξₙ}. When this occurs, the process will go back to box #4 of FIG. 2A (the outer-loop), re-starting the process of iteration of raw-image alignment to the updated SR-image.

The progress of an SR refinement can be monitored by the scoring function S, and the procedure terminates when no further improvement in S can be achieved using the outer loop (back to box #4 of FIG. 2A).

### Example 3

### Method of 3D Density Map Refinement

The 2D SR-refinement algorithm can be extended to 3D density maps, though the computational complexity is higher due to the large number of voxels in a density map. In preparing the SR template, a density map reconstructed from the raw data can be over-sampled, for example, via padding in the Fourier space. Also, replacing the notation I_{SR} in 2D by M_{SR} in 3D (for a SR-map), the scoring function is described by Equation (3)

$$S = {\sum }_{n = 1}^{N} {CC}_{n} = {\sum }_{n = 1}^{N} bin ( P ( {M}_{SR} , {ξ}_{n} ) ) ⊗ {F}_{n} \qquad ( 3 )$$

where the alignment parameter {ξ} extends to a quintuple α, β, δ, dx, dy (three Euler angles and two in-plane translations), and P is the projection operator from the 3D density map to 2D images. The flowchart in FIG. 2B illustrates the SR-refinement algorithm for the 3D case.

### Example 4

### Demonstration of 2D Image Merging

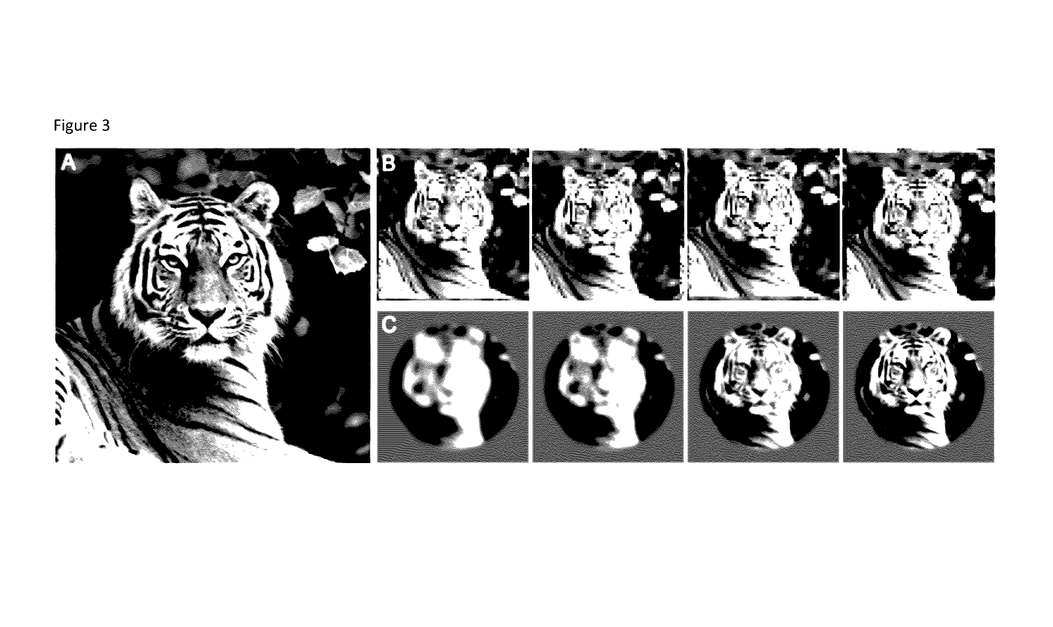

In this example, the SR-refinement algorithm was validated on synthetic, noise-free images. A high-resolution photograph (FIG. 3A, 1024×1024 pixels) was used as the source to generate a stack of binned images with random X/Y-shifts (between 0-32 pixels). Each randomly shifted image was then binned by 16-fold to produce one “raw” image (64×64 pixels, with subpixel translation between 0.0-2.0 pixels). The full synthetic dataset included 2,000 such shifted and down-sampled resolution frames. FIG. 3B illustrates raw images are from the original in FIG. 3A. The facial texture of the tiger varied across the frames because of the random subpixel translations. The alignment of raw images can be initialized via a self-alignment procedure that is often used in single-particle EM data analysis. In this test, however, all the initial alignments are set to 0, leaving the registration search to the algorithm. The direct sum of the raw image stack produces a blurry image (FIG. 3C left panel), which is then 2x-oversampled (128×128 pixels) to serve as the initial template of the SR-image I_{SR} in step 3 of flowchart in FIG. 2.

Following the refinement procedure, the stack of low resolution raw images are merged into a single SR-image (128×128 pixels), which visually contains richer information. The score S (Eq. 1) increases from 0.868 to 0.979 as the refinement progresses. To evaluate the real quality of the SR-image, the high-resolution image source of FIG. 3A is 8-fold binned to create a “ground-truth” target (128×128 pixels) for comparison to the SR-image. The cross-correlation between the SR-image and the reference target reaches 0.990 at the end of the refinement (FIG. 3C right panel).

Example 5

### Demonstration of 3D Density Map Refinement

To test the SR refinement in 3D, a synthetic particle stack was generated from the atomic structure of the yeast 20S proteasome (PDB code: 3MG0). A density map of the 20S proteasome (256×256×256 in dimension) at 2.0 Å resolution was first constructed at 1.0 Å/voxel from the PDB model, which was then projected to 2D images (256×256 pixels) using random alignment parameters with full Euler angle coverage and 8-pixel maximal image shift. For simplicity, the projection was exclusively geometric without any imaging artifacts (CTF, radiation damage, beam-induced specimen movement, etc.). Then, the full-size projections were 4-fold binned to 64×64 frames (4.0 Å/pixel) that contain random in-plane shifts of 0.0-2.0 pixels. A stack of 2,000 particles was generated to be used as the raw images for the SR-refinement.

To establish the initial alignment of the raw images, the original projection parameters were borrowed and “refined” through the standard projection-matching procedure described in FIG. 2 within the physical resolution. Upon convergence, the 3D reconstruction from the raw images was over-sampled by 2-fold in the Fourier space to serve as the initial SR template map.

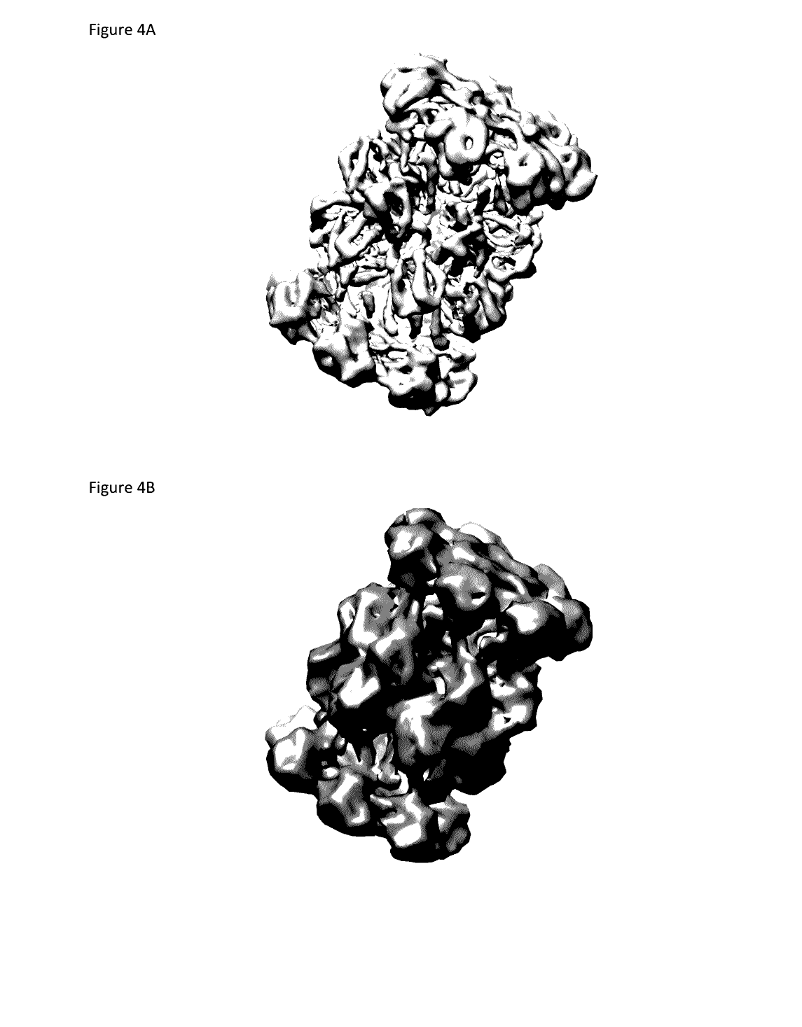

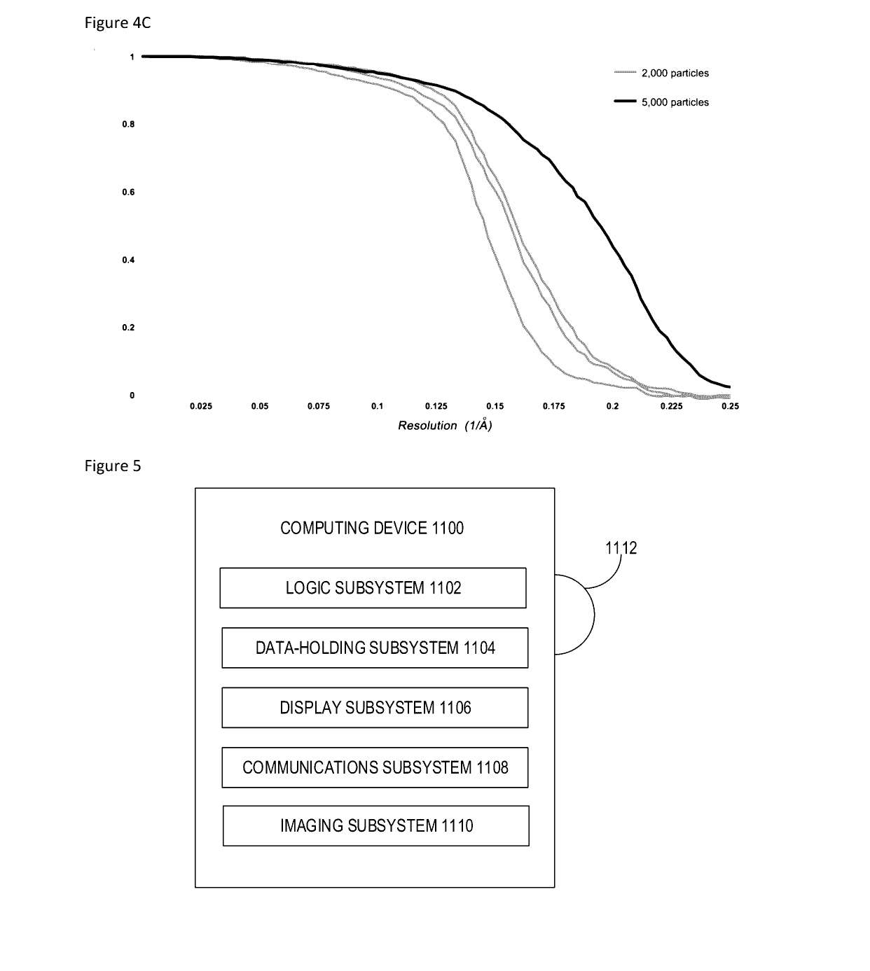

Using the method described herein, the SR-refinement was able to recover a significant amount of information at higher resolution (FIG. 4A and 4B). To evaluate the quality of the refined SR-maps, a ground-truth standard was created from the original PDB model at 2.0 Å/voxel spacing. Assessed by Fourier Shell Correlation (FSC=0.143) with the standard, the resolution of the SR-map reached 5.3 Å from the 2000 particle stack (gray curves in FIG. 4C), well beyond the Nyquist frequency of the raw data at 8.0 Å.

To further assess the dependence of the algorithm on the amount of data input, another 20S proteasome particle stack comprised of 5000 particles was synthesized as described above. The larger dataset resulted in more high-frequency signal embedded in random image shifts, and as a result, the refined SR-map gained resolution up to 4.4 Å (the black curve in FIG. 4C). Note that the FSC remains nontrivial at 4 Å (the Nyquist frequency of the SR-map), indicating that an even larger dataset would enable the SR refinement to achieve even better resolution.

FIG. 5 schematically shows a non-limiting computing device 1100 that can perform one or more of the above described methods and processes. For example, computing device 1100 can represent a processor included in system 1000 described above, and can be operatively coupled to, in communication with, or included in an OCT system or OCT image acquisition apparatus. Computing device 1100 is shown in simplified form. It is to be understood that virtually any computer architecture can be used without departing from the scope of this disclosure. In different embodiments, computing device 1100 can take the form of a microcomputer, an integrated computer circuit, printed circuit board (PCB), microchip, a mainframe computer, server computer, desktop computer, laptop computer, tablet computer, home entertainment computer, network computing device, mobile computing device, mobile communication device, gaming device, etc.

Computing device 1100 includes a logic subsystem 1102 and a data-holding subsystem 1104. Computing device 1100 can optionally include a display subsystem 1106, a communication subsystem 1108, an imaging subsystem 1110, and/or other components not shown in FIG. 11. Computing device 1100 can also optionally include user input devices such as manually actuated buttons, switches, keyboards, mice, game controllers, cameras, microphones, and/or touch screens, for example.

Logic subsystem 1102 can include one or more physical devices configured to execute one or more machine-readable instructions. For example, the logic subsystem can be configured to execute one or more instructions that are part of one or more applications, services, programs, routines, libraries, objects, components, data structures, or other logical constructs. Such instructions can be implemented to perform a task, implement a data type, transform the state of one or more devices, or otherwise arrive at a desired result.

The logic subsystem can include one or more processors that are configured to execute software instructions. For example, the one or more processors can comprise physical circuitry programmed to perform various acts described herein. Additionally or alternatively, the logic subsystem can include one or more hardware or firmware logic machines configured to execute hardware or firmware instructions. Processors of the logic subsystem can be single core or multicore, and the programs executed thereon can be configured for parallel or distributed processing. The logic subsystem can optionally include individual components that are distributed throughout two or more devices, which can be remotely located and/or configured for coordinated processing. One or more aspects of the logic subsystem can be virtualized and executed by remotely accessible networked computing devices configured in a cloud computing configuration.

Data-holding subsystem 1104 can include one or more physical, non-transitory, devices configured to hold data and/or instructions executable by the logic subsystem to implement the herein described methods and processes. When such methods and processes are implemented, the state of data-holding subsystem 1104 can be transformed (e.g., to hold different data).

Data-holding subsystem 1104 can include removable media and/or built-in devices. Data-holding subsystem 1104 can include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 1104 can include devices with one or more of the following characteristics: volatile, nonvolatile, dynamic, static, read/write, read-only, random access, sequential access, location addressable, file addressable, and content addressable. In some embodiments, logic subsystem 1102 and data-holding subsystem 1104 can be integrated into one or more common devices, such as an application specific integrated circuit or a system on a chip.

FIG. 5 also shows an aspect of the data-holding subsystem in the form of removable computer-readable storage media 1112, which can be used to store and/or transfer data and/or instructions executable to implement the herein described methods and processes. Removable computer-readable storage media 1112 can take the form of CDs, DVDs, HD-DVDs, Blu-Ray Discs, EEPROMs, flash memory cards, USB storage devices, and/or floppy disks, among others.

When included, display subsystem 1106 can be used to present a visual representation of data held by data-holding subsystem 1104. As the herein described methods and processes change the data held by the data-holding subsystem, and thus transform the state of the data-holding subsystem, the state of display subsystem 1106 can likewise be transformed to visually represent changes in the underlying data. Display subsystem 1106 can include one or more display devices utilizing virtually any type of technology. Such display devices can be combined with logic subsystem 1102 and/or data-holding subsystem 1104 in a shared enclosure, or such display devices can be peripheral display devices.

When included, communication subsystem 1108 can be configured to communicatively couple computing device 1100 with one or more other computing devices. Communication subsystem 1108 can include wired and/or wireless communication devices compatible with one or more different communication protocols. As non-limiting examples, the communication subsystem can be configured for communication via a wireless telephone network, a wireless local area network, a wired local area network, a wireless wide area network, a wired wide area network, etc. In some embodiments, the communication subsystem can allow computing device 1100 to send and/or receive messages to and/or from other devices via a network such as the Internet.

When included, imaging subsystem 1110 can be used acquire and/or process any suitable image data from various sensors or imaging devices in communication with computing device 1100. For example, imaging subsystem 1110 can be configured to acquire OCT image data, e.g., interferograms, as part of an OCT system, e.g., OCT system 1002 described above. Imaging subsystem 1110 can be combined with logic subsystem 1102 and/or data-holding subsystem 1104 in a shared enclosure, or such imaging subsystems can comprise periphery imaging devices. Data received from the imaging subsystem can be held by data-holding subsystem 1104 and/or removable computer-readable storage media 1112, for example.

It is to be understood that the configurations and/or approaches described herein are exemplary in nature, and that these specific embodiments or examples are not to be considered in a limiting sense, because numerous variations are possible. The specific routines or methods described herein can represent one or more of any number of processing strategies. As such, various acts illustrated can be performed in the sequence illustrated, in other sequences, in parallel, or in some cases omitted. Likewise, the order of the above-described processes can be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of increasing the information content of a 2-dimensional digital image, the method comprising:
obtaining a set of n raw images, each raw image comprising an m×m pixel array containing a random 2-D affine transformation;
generating an initial registration ξₙ from the set of images, thereby generating a registered frame stack F′ₙ;
summing the images in the registered frame stack F′ₙ to generate an image template I₀;
oversampling I₀ by a factor κ greater than 1.0, thereby creating a super resolution image template I_{SR}, the super resolution image template comprising a κm×κm pixel array;
calculating a first score S by a scoring function;
selecting a first pixel of the I_{SR} and modifying the intensity of the first pixel by a first amount Δ, thereby generating a first modified super resolution image I′_{SR};
calculating a first score S′ of the I′_{SR} using the scoring function;
comparing S′ to S; and
accepting the modification by the first amount Δ and substituting I′_{SR} for I_{SR} and substituting S′ for S; thereby increasing the information content of the image provided that the first score S′ is greater than the first score S.

2. The method of claim 1 further comprising oversampling through Fourier padding, bilinear interpolation, bicubic interpolation, spline interpolation, B-spline interpolation, nearest neighbor interpolation, or cubic convolution.

3. The method of claim 1 comprising oversampling I₀ by a factor greater than 1.5.

4. The method of claim 1 further comprising selecting a second pixel of the I_{SR} and modifying the intensity of the second pixel by a second amount Δ′ thereby generating a second modified super resolution image I″_{SR}; calculating a second score S″ of the I″_{SR} using the scoring function; comparing S″ to S; and accepting the modification by Δ′ and substituting I″_{SR} for I_{SR} and substituting S″ for S provided that the second score S″ is greater than the score S.

5. The method of claim 1 wherein the scoring function is Equation (1).

6. The method of claim 1 wherein the first amount A is calculated by Equation (2).

7. The method of claim 1 wherein the random 2-D affine transformations are generated by stochastic, naturally occurring, or mechanical methods during image acquisition.

8. The method of claim 1 wherein the first pixel is selected at random or systematically.

9. The method of claim 1 wherein the 2-D affine transformation comprises X/Y translations and/or in-plane rotation θ and/or a scaling factor;

10. The method of claim 1 further comprising obtaining the image set from an electron microscope, a light microscope, a radio telescope, an OCT device, or a CCD camera.

11. A method of increasing the information content of a 3-dimensional digital image, the method comprising:
obtaining a set of n 2-D raw images, the set of 2-D raw images comprising random projections of a 3-D object;
generating an initial registration ξₙ from the set of raw images, thereby generating a registered frame stack F′ₙ;
combining the registered images in F′ₙ to generate an initial 3-D map M₀;
oversampling M₀ by a factor κ greater than 1.0, thereby creating a super resolution 3-D map template M_{SR};
calculating a first score S using a scoring function;
selecting a first voxel of the M_{SR} and modifying the intensity of the first voxel by a first amount Δ, thereby generating a first modified super resolution map M′_{SR};
calculating a first score S′ of the M′_{SR} using the scoring function;
comparing S′ to S; and
accepting the modification by Δ and substituting M′_{SR} for M_{SR} and substituting S′ for S, thereby increasing the information content of the map provided that the first score S′ is greater than the first score S.

12. The method of claim 11 further comprising oversampling through Fourier padding, bicubic interpolation, spline interpolation, B-spline interpolation, nearest neighbor interpolation, cubic convolution, or any other form of resampling algorithm.

13. The method of claim 11 comprising oversampling M₀ by a factor greater than 1.0.

14. The method of claim 11 further comprising selecting a second voxel of the M_{SR} and modifying the intensity of the second voxel by a second amount Δ′ thereby generating a second modified super resolution image M″_{SR}; calculating a second score S″ of the M″_{SR} using the scoring function, comparing S″ to S; and accepting the modification by Δ and substituting M″_{SR} for M_{SR} and substituting S″ for S provided that the second score S″ is greater than the score S.

15. The method of claim 11 wherein the scoring function is calculated using Equation (3).

16. The method of claim 11 wherein Δ is calculated using Equation (2).

17. The method of claim 11 wherein the 2-D raw images contain random subpixel 2D affine transformations generated by stochastic, naturally occurring, or mechanical methods during image acquisition.

18. The method of claim 11 wherein the first voxel is selected at random or systematically.

19. The method of claim 11 further comprising obtaining the image set from an electron microscope, a light microscope, a radio telescope, an OCT device, or a CCD camera.
